(19) United States
(12) Patent Application Publication
(10) Pub. No.: US 2025/0368421 A1
(43) Pub. Date: Dec. 4, 2025

(54) VACUUM FOOD STORAGE BARREL

(71) Applicant: SHENZHEN UAH TECHNOLOGY CO., LTD, Shenzhen (CN)

(72) Inventors: Shengbo LU, Shenzhen (CN); Qiang GENG, Shenzhen (CN); Xiaojun ZHOU, Shenzhen (CN); Shen TIAN, Shenzhen (CN); Weixin LUO, Shenzhen (CN); Biting WEN, Shenzhen (CN)

(73) Assignee: SHENZHEN UAH TECHNOLOGY CO., LTD, Shenzhen (CN)

(21) Appl. No.: 18/778,073

(22) Filed: Jul. 19, 2024

(30) Foreign Application Priority Data
May 31, 2024 (CN) 202421232771.9

(51) Int. Cl. B65D 81/20; B65D 81/26

(52) U.S. Cl. CPC B65D 81/2038; B65D 81/264; B65D 2205/02

(57) ABSTRACT

A vacuum food storage barrel includes a vacuum pump assembly, an induction assembly, a barrel lid, and a barrel body provided with a storage space. The barrel lid is rotatably installed on the barrel body and used for covering the storage space; the vacuum pump assembly and the introduction assembly are both installed on the barrel lid, and the vacuum pump assembly and the introduction assembly are electrically connected; and the induction assembly is used for pumping the storage space into a vacuum state through the vacuum pump assembly when the barrel lid is lifted on the barrel body. According to the present application, the vacuum pump assembly can be automatically triggered in the process of closing the barrel lid, eliminating the need to manually press buttons. The vacuum food storage barrel offers enhanced convenience and user experience.

### CROSS-REFERENCE TO RELATED APPLICATIONS

This application claims priority to Chinese Patent Application No. 202421232771.9, filed on May 31, 2024, the content of which is incorporated herein by reference in its entirety.

### TECHNICAL FIELD

The present application belongs to the technical field of food storage barrels, in particular to a vacuum food storage barrel.

### BACKGROUND

Vacuum storage devices are commonly used to keep food for humans and animals. Food stored in vacuum storage devices can have a longer shelf life. In the prior art, the vacuum storage device is typically equipped with a trigger button; however, when the vacuum storage device needs to be vacuumed, the user requires the trigger button. This type of vacuum storage device, which requires manual activation of the button to vacuumize, has some drawbacks such as inconvenient operation and a poor user experience.

### SUMMARY

To address the technical problem that the vacuum storage device in the prior art requires manual activation of a button to perform the vacuuming process, the present application provides a vacuum food storage barrel.

In view of the above technical problems, the embodiments of the application provide a vacuum food storage barrel, including a vacuum pump assembly, an induction assembly, a barrel lid and a barrel body with a storage space. The barrel lid is rotatably installed on the barrel body and used for covering the storage space; the vacuum pump assembly and the introduction assembly are both installed on the barrel lid, and the vacuum pump assembly and the introduction assembly are electrically connected; and the induction assembly is used for pumping the storage space into a vacuum state through the vacuum pump assembly when the barrel lid is lifted on the barrel body.

Optionally, the vacuum food storage barrel further includes a pressure relief assembly and a lock hook rotatably installed on the barrel lid, a clamping part is arranged on an outer wall of the barrel body; the barrel lid covers the barrel body through the lock hook clamped on the clamping part; the lock hook is used for releasing the pressure of the storage space through the pressure relief assembly when the lock hook is disengaged from the clamping part.

Optionally, the barrel lid is provided with a pressure relief hole, and the pressure relief assembly includes a first elastic member and a pushing piece slidably installed on the barrel lid; two opposite sides of the pushing piece are respectively provided with a sealing part and a guide rod; the first elastic member is sleeved on the guide rod and abutted with the barrel lid; the pushing piece is also provided with a pushing part abutting against the lock hook; when the lock hook abuts against the clamping part, a rebound force of the first elastic member drives the sealing part to seal the pressure relief hole; and when the lock hook is disengaged from the clamping part, the lock hook drives the pushing piece to move by the pushing part, so that the sealing part unblocks the pressure relief hole.

Optionally, the barrel body is further provided with a trigger part; the induction assembly includes a trigger lever, a second elastic member and a trigger switch electrically connected with the vacuum pump assembly; one end of the trigger lever is abutted with the trigger switch and used for triggering the trigger switch, and another end of the trigger lever is abutted with or detached from the trigger part; the second elastic member is sleeved on the trigger lever and abutted with the barrel lid; and when the barrel lid covers the barrel body, the trigger part drives the trigger lever to move to trigger the trigger switch, and the vacuum pump assembly pumps the storage space into a vacuum state.

Optionally, the barrel lid is provided with a mounting groove, and an inner wall of the mounting groove is provided with an air suction hole communicating with the storage space; the vacuum food storage barrel further includes a check valve installed in the air suction hole; the vacuum pump assembly includes an accommodation shell provided with an accommodation space, and a vacuum pump and a control panel both installed in the accommodation space; the control panel is electrically connected with both the vacuum pump and the induction assembly; the accommodation shell is provided with an insertion part, and the insertion part is provided with a through hole communicated with the accommodation space, and the air suction hole of the vacuum pump is communicated with the through hole; and when the accommodation shell is installed in the mounting groove, the check valve is inserted into the through hole, and the through hole communicates with the storage space through the check valve.

Optionally, the accommodation shell is provided with a first electrical contact electrically connected with the control panel, and the mounting groove is provided with a second electrical contact electrically connected with the induction assembly; and when the accommodation shell is installed in the mounting groove, the first electrical contact is electrically connected with the second electrical contact.

Optionally, the vacuum pump assembly further includes a vacuum sensor installed in the accommodation space and electrically connected with the control panel, and the vacuum sensor is communicated with the through hole and used for detecting a vacuum degree of the storage space.

Optionally, the barrel lid includes an upper lid and a lower lid installed on the upper lid, and an internal space is arranged between the upper lid and the lower lid; the vacuum pump assembly is detachably installed on the upper lid, and the induction assembly is installed in the internal space.

Optionally, the vacuum food storage barrel further includes a sealing ring, the sealing ring includes a first annular part, a second annular part and a connection part connected between the first annular part and the second annular part; an annular groove is arranged between the first annular part and the second annular part, one end of the first annular part facing the annular groove is provided with a plurality of convex parts distributed at intervals, and the convex part extends towards the second annular part; the sealing ring is installed on the barrel lid through the first annular part; and when the barrel lid covers the barrel body, one end of the second annular part abuts against an opening edge of the barrel lid, and another end of the second annular part abuts against the convex part.

Optionally, the vacuum food storage barrel further includes a storage box detachably installed on the barrel lid or the barrel body and positioned in the storage space; and/or the barrel lid is also provided with a desiccant detachably installed on the barrel lid, and the desiccant is used for drying the storage space.

According to the present application, when the barrel lid covers the barrel body, the barrel lid triggers the induction assembly. The induction assembly will trigger the vacuum pump assembly. The vacuum pump assembly will automatically vacuum the storage space of the barrel body into a vacuum state. In this way, the vacuum pump assembly can be automatically triggered in the process of closing the barrel lid, eliminating the need to manually press buttons, improving the convenience and user experience of the vacuum food storage barrel.

### BRIEF DESCRIPTION OF THE DRAWINGS

The application will be further explained in detail below with reference to the drawings and embodiments.

FIG. 1 is a structural schematic diagram of a vacuum food storage barrel provided by an embodiment of the present application.

FIG. 2 is a sectional view of a vacuum food storage barrel provided by an embodiment of the present application.

FIG. 3 is an enlarged view of part A shown in FIG. 2.

FIG. 4 is an enlarged view of part B shown in FIG. 2.

FIG. 5 is a structural schematic diagram of a barrel lid of a vacuum food storage barrel provided by an embodiment of the present application.

FIG. 6 is a structural schematic diagram of a vacuum pump assembly of a vacuum food storage barrel provided by an embodiment of the present application.

FIG. 7 is a partial structural diagram of a vacuum pump assembly of a vacuum food storage barrel provided by an embodiment of the present application.

FIG. 8 is a cross-sectional view of a sealing ring of a vacuum food storage barrel provided by an embodiment of the present application.

The reference signs in the drawings are as follows.

1. Vacuum pump assembly; 11. Accommodation shell; 111. Accommodation space; 112. Insertion part; 113. First electrical contact; 12. Vacuum pump; 13. Control panel; 14. Battery; 2. Induction assembly; 21. Trigger lever; 22. Second elastic member; 23. Trigger switch; 3. Barrel lid; 31. Lock hook; 32. Pressure relief hole; 33. Check valve; 34. Mounting groove; 35. Second electrical contact; 36. Upper lid; 37. Lower lid; 38. Internal space; 4. Barrel body; 41. Storage space; 42. Clamping part; 43. Trigger part; 5. Pressure relief assembly; 51. First elastic member; 52. Pushing piece; 521. Sealing part; 522. Guide rod; 523. Pushing part; 6. Sealing ring; 61. First annular part; 62. Second annular part; 63. Connection part; 64. Annular groove; 65. Convex part; 7. Storage box.

### DETAILED DESCRIPTION OF THE EMBODIMENTS

In order to make the technical problems, technical solutions and beneficial effects of the present application more clear, the application will be further explained in detail below with reference to the drawings and embodiments. It should be understood that the specific embodiments described here are only used to illustrate the application, rather than to limit the application.

It should be understood that the terms “upper”, “lower”, “front”, “rear”, “left”, “right”, “middle part”, and the like indicate an orientation or positional relationship based on that shown in the drawings, and are for convenience of description and simplicity of description only, not intended to indicate or imply that the indicated devices or elements must have a particular orientation, be constructed and operated in a particular orientation, and are therefore not to be construed as limiting the present application.

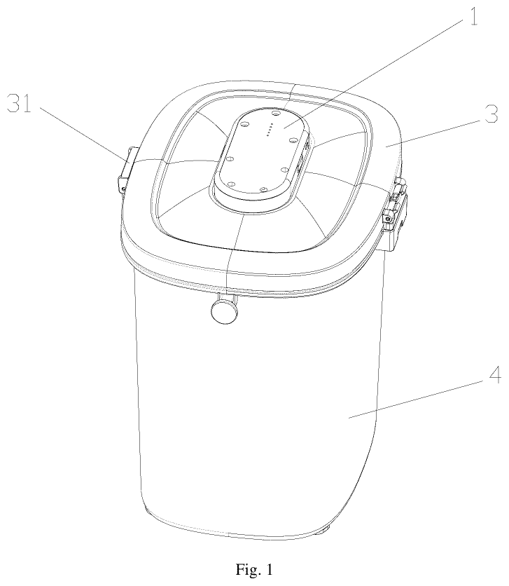

As shown in FIG. 1 to FIG. 3, a vacuum food storage barrel provided by an embodiment of the present application includes a vacuum pump assembly 1, an induction assembly 2, a barrel lid 3 and a barrel body 4 provided with a storage space 41; the barrel lid 3 is rotatably mounted on the barrel body 4 and is used for covering the storage space 41. Understandably, the upper part of the barrel body 4 has an open structure.

The vacuum pump assembly 1 and the induction assembly 2 are both installed on the barrel lid 3, and the vacuum pump assembly 1 and the induction assembly 2 are electrically connected. Understandably, the induction assembly 2 includes but is not limited to a trigger switch 23, a trigger sensor, and the like.

The induction assembly 2 is used for pumping the storage space 41 into a vacuum state through the vacuum pump assembly 1 when the barrel lid 3 is lifted on the barrel body 4.

Specifically, when the barrel lid 3 covers the barrel body 4, the barrel lid 3 will trigger the induction assembly 2, and the induction assembly 2 will then trigger the vacuum pump assembly 1. The vacuum pump assembly 1 will automatically vacuum the storage space 41 of the barrel body 4 into a vacuum state. In this way, the vacuum pump assembly 1 can be automatically triggered in the process of closing the barrel lid 3, eliminating the need to manually press buttons, improving the convenience and user experience of the vacuum food storage barrel.

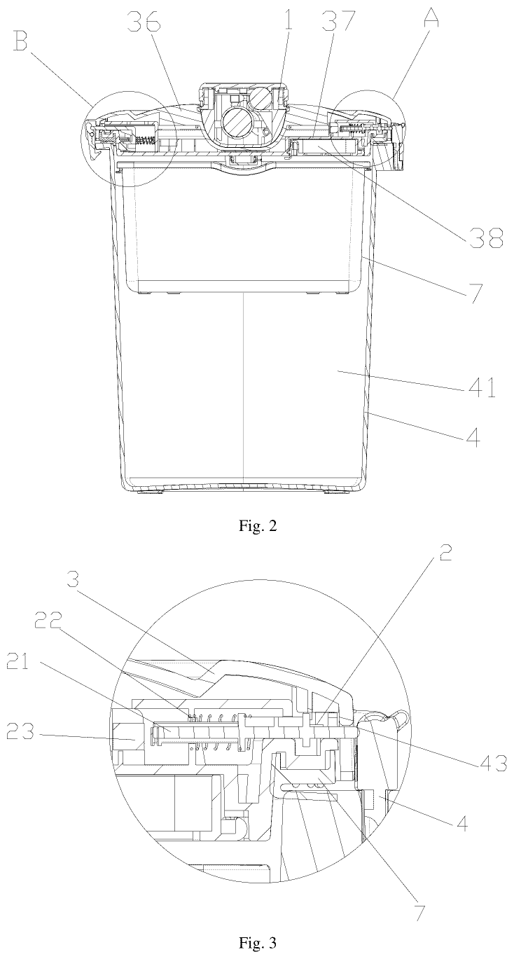

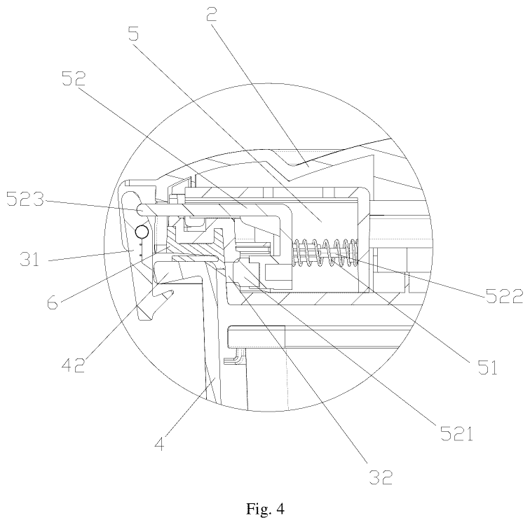

In an embodiment, as shown in FIGS. 2 and 4, the vacuum food storage barrel further includes a pressure relief assembly 5 and a lock hook 31 rotatably installed on the barrel lid 3, a clamping part 42 is arranged on an outer wall of the barrel body 4; the barrel lid 3 covers the barrel body 4 through the lock hook 31 clamped on the clamping part 42; the lock hook 31 is used for releasing the pressure of the storage space 41 through the pressure relief assembly 5 when the lock hook 31 is disengaged from the clamping part 42. Understandably, the lock hook 31 is not only used to enable the barrel lid 3 to cover the barrel body 4 through the clamping part 42, but also used to trigger the pressure relief assembly 5 to release the pressure of the storage space 41 in a vacuum state through the pressure relief assembly 5.

Specifically, the barrel lid 3 covers the barrel body 4 through the lock hook 31 clamped on the clamping part 42. When the barrel lid 3 needs to be lifted from the barrel body 4, the lock hook 31 is toggled to be disengaged from the clamping part 42. In the process of toggling the lock hook 31, the lock hook 31 will trigger the pressure relief assembly 5, and the pressure relief assembly 5 will release the pressure of the storage space 41. The released storage space 41 will facilitate the lifting of the barrel lid 3 from the barrel body 4.

In an embodiment, as shown in FIGS. 2 and 4, the barrel lid 3 is provided with a pressure relief hole 32, and the pressure relief assembly 5 includes a first elastic member 51 and a pushing piece 52 slidably installed on the barrel lid 3; two opposite sides of the pushing piece 52 are respectively provided with a sealing part 521 and a guide rod 522; the first elastic member 51 is sleeved on the guide rod 522 and abutted with the barrel lid 3. Understandably, the two opposite ends of the first elastic member 51 abut against the pushing piece 52 and the barrel lid 3 respectively, and the first elastic member 51 is used to drive the pushing piece 52 to reset.

The pushing piece 52 is also provided with a pushing part 523 abutting against the lock hook 31. Understandably, the pushing part 523 extends from the barrel lid 3 and abuts against the lock hook 31.

When the lock hook 31 abuts against the clamping part 42, a rebound force of the first elastic member 51 drives the sealing part 521 to seal the pressure relief hole 32. Specifically, when the barrel lid 3 covers the barrel body 4, the lock hook 31 is engaged with the clamping part 42. The rebound force of the first elastic member 51 will drive the trigger part 43 to move toward the lock hook 31 until the sealing part 521 is inserted into the pressure relief hole 32, so that the pressure relief hole 32 is in a closed state.

When the lock hook 31 is disengaged from the clamping part 42, the lock hook 31 drives the pushing piece 52 to move by the pushing part 523, so that the sealing part 521 unblocks the pressure relief hole 32. Specifically, when the lock hook 31 is toggled, the lock hook 31 is disengaged from the clamping part 42. In the process of toggling the lock hook 31, the lock hook 31 drives the pushing piece 52 to move by the pushing part 523 until the sealing part 521 is separated from the pressure relief hole 32, so that the pressure relief hole 32 is in a conducting state. And the storage space 41 is depressurized through the pressure relief hole 32 that in the conducting state, thereby making it easier to lift the barrel lid 3 from the barrel body 4. Further, when the lock hook 31 drives the pushing piece 52 to move, the pushing piece 52 will press the first elastic member 51. In this embodiment, the pressure relief assembly 5 has a simple structure and low manufacturing cost.

In an embodiment, as shown in FIGS. 2 and 3, the barrel body 4 is further provided with a trigger part 43; the induction assembly 2 includes a trigger lever 21, a second elastic member 22 and a trigger switch 23 electrically connected with the vacuum pump assembly 1; one end of the trigger lever 21 is abutted with the trigger switch 23 and used for triggering the trigger switch 23, and another end of the trigger lever 21 is abutted with or detached from the trigger part 43; the second elastic member 22 is sleeved on the trigger lever 21 and abutted with the barrel lid 3. Understandably, the second elastic member 22 includes, but is not limited to, a spring, etc. The opposite ends of the second elastic member 22 abut against the trigger lever 21 and the barrel lid 3 respectively, and the second elastic member 22 is used for resetting the trigger lever 21.

When the barrel lid 3 covers the barrel body 4, the trigger part 43 drives the trigger lever 21 to move to trigger the trigger switch 23, and the vacuum pump assembly 1 pumps the storage space 41 into a vacuum state.

Specifically, when the barrel lid 3 covers the barrel body 4, the trigger part 43 on the barrel body 4 will push the trigger lever 21 to move towards the trigger switch 23 until the trigger switch 23 is triggered by the end of the trigger lever 21 away from the trigger part 43. The vacuum pump assembly 1 will automatically vacuum the storage space 41 into a vacuum state after the trigger switch 23 is triggered. In this embodiment, the induction assembly 2 has a simple structure and low manufacturing cost.

Further, the barrel body 4 is provided with a groove. When the barrel lid 3 is lifted from the barrel body 4, the rebound force of the second elastic member 22 will make the end of the trigger lever 21 away from the trigger switch 23 extend into the groove, and the end of the trigger lever 21 away from the groove will be separated from the trigger switch 23.

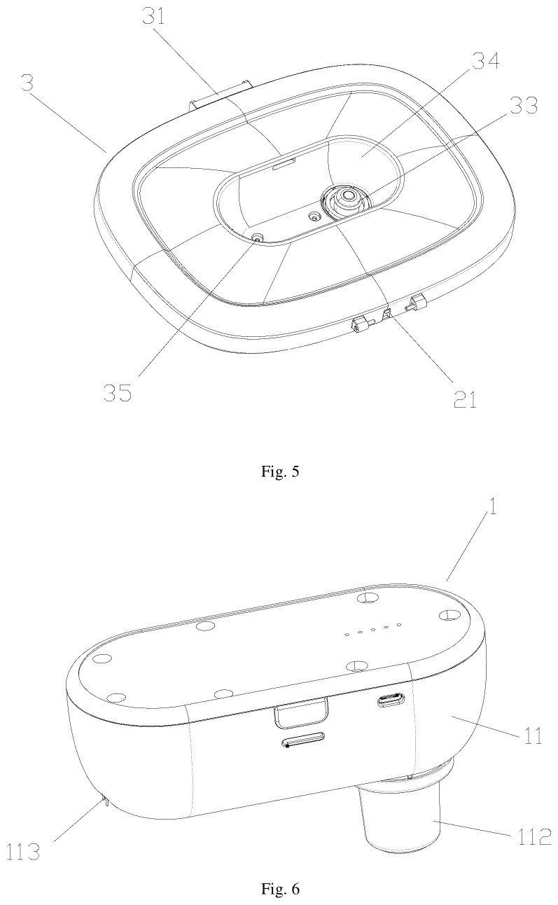

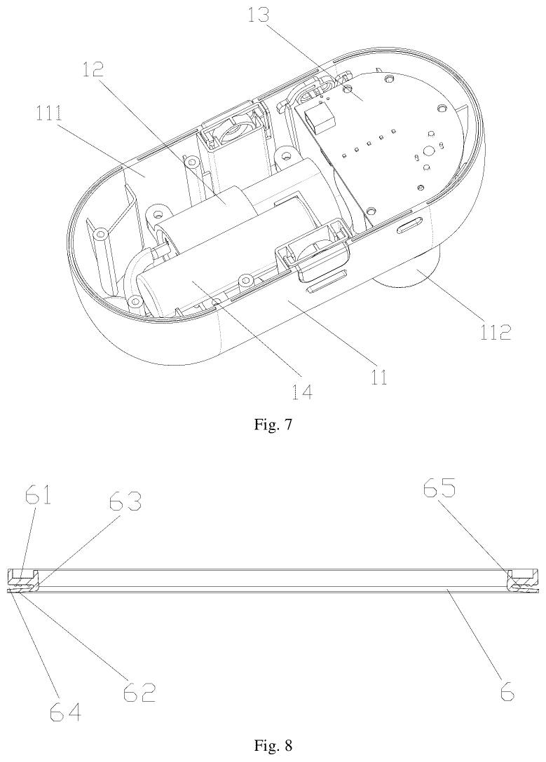

In an embodiment, as shown in FIGS. 5 to 7, the barrel lid is provided with a mounting groove 34, and an inner wall of the mounting groove 34 is provided with an air suction hole communicating with the storage space 41; the vacuum food storage barrel further includes a check valve 33 installed in the air suction hole. Understandably, the mounting groove 34 is arranged at the top of the barrel lid 3, and when the barrel lid 3 covers the barrel body 4, the check valve 33 communicates with the storage space 41.

The vacuum pump assembly 1 includes an accommodation shell 11 provided with an accommodation space 111, and a vacuum pump 12 and a control panel 13 both installed in the accommodation space 111; the control panel 13 is electrically connected with both the vacuum pump 12 and the induction assembly 2. Preferably, the accommodation shell 11 includes a shell and a shell cover detachably covering the shell. The accommodation space 111 is arranged on the shell.

The accommodation shell 11 is provided with an insertion part 112, and the insertion part 112 is provided with a through hole communicated with the accommodation space 111, and the air suction hole of the vacuum pump 12 is communicated with the through hole. Understandably, the insertion part 112 is arranged at the bottom of the accommodation shell 11 and extends downward.

When the accommodation shell 11 is installed in the mounting groove 34, the check valve 33 is inserted into the through hole, and the through hole communicates with the storage space 41 through the check valve 33.

Specifically, when the accommodation shell 11 is installed in the mounting groove 34 of the barrel lid 3, the check valve 33 is inserted into the through hole, and the check valve 33 is in a conducting state. The air suction hole of the vacuum pump 12 communicates with the storage space 41 through the through hole and the check valve 33 in turn. In this way, the vacuum pump 12 can vacuum the storage space 41 into a vacuum state. After the accommodation shell 11 is detached from the barrel lid 3, the check valve 33 is in a closed state, so that the storage space 41 will not be depressurized through the check valve 33. In this embodiment, the vacuum pump assembly 1 can be detached from the barrel lid 3 and used separately, thus improving the applicability and universality of the vacuum food storage barrel.

Further, the vacuum pump assembly 1 further includes a battery 14 installed in the accommodation space 111, and the battery 14 is electrically connected with the control panel 13. The battery 14 can provide power for the control panel 13, the vacuum pump 12 and the trigger switch 23.

In an embodiment, as shown in FIGS. 5 and 6, the accommodation shell 11 is provided with a first electrical contact 113 electrically connected with the control panel 13, and the mounting groove 34 is provided with a second electrical contact 35 electrically connected with the induction assembly 2. Understandably, the first electrical contact 113 and the second electrical contact 35 include, but are not limited to, contact pin and socket contact. The first electrical contact 113 is arranged at the bottom of the accommodation shell 11 and extends downward.

When the accommodation shell 11 is installed in the mounting groove 34, the first electrical contact 113 is electrically connected with the second electrical contact 35. Specifically, after the accommodation shell 11 is installed in the mounting groove 34, the first electrical contact 113 contacts the second electrical contact 35. Therefore, the control panel 13 will be electrically connected with the trigger switch 23 through the first electrical contact 113 and the second electrical contact 35 which are in contact with each other. When the bottom of the accommodation shell 11 is separated from the mounting groove 34, the first electrical contact 113 is disconnected from the second electrical contact 35.

In an embodiment, the vacuum pump assembly 1 further includes a vacuum sensor (not shown in the figures) installed in the accommodation space 111 and electrically connected with the control panel 13. The vacuum sensor communicates with the through hole and is used for detecting the vacuum degree of the storage space 41. Specifically, when the barrel lid 3 covers the barrel body 4, the vacuum sensor can detect the vacuum degree of the storage space 41 in real time. When the vacuum sensor detects that the vacuum degree of the storage space 41 is less than a preset pressure, the control panel 13 will control the vacuum pump 12 to vacuum the storage space 41. When the vacuum sensor detects that the vacuum degree of the storage space 41 is greater than or equal to the preset pressure, the control panel 13 will control the vacuum pump 12 to stop vacuuming the storage space 41. In this embodiment, the arrangement of the vacuum sensor improves the automation degree of the vacuum food storage barrel.

In an embodiment, as shown in FIG. 2, the barrel lid 3 includes an upper lid 36 and a lower lid 37 installed on the upper lid 36, and an internal space 38 is arranged between the upper lid 36 and the lower lid 37. The vacuum pump assembly 1 is detachably installed on the upper lid 36, and the induction assembly 2 is installed in the internal space 38. It should be noted that the pressure relief assembly 5 is also installed in the internal space 38. One end of the trigger lever 21 away from the trigger switch 23 extends from the internal space 38, and the pushing part 523 of the pushing piece 52 extends from the internal space 38. In this embodiment, the barrel lid 3 is composed of the upper lid 36 and the lower lid 37. The induction assembly 2 and the pressure relief assembly 5 are hidden in an internal space 38 between the upper lid 36 and the lower lid 37. Thus, the intrusion of external environment on the induction assembly 2 and the pressure relief assembly 5 is avoided, and the service life of the vacuum food storage barrel is prolonged.

In an embodiment, the inner side wall of the lower lid 37 is provided with honeycomb ribs. The design of the honeycomb ribs enhances the strength and rigidity of the barrel lid 3.

In an embodiment, as shown in FIG. 2 and FIG. 8, the vacuum food storage barrel further includes a sealing ring 6, the sealing ring 6 includes a first annular part 61, a second annular part 62 and a connection part 63 connected between the first annular part 61 and the second annular part 62; an annular groove 64 is arranged between the first annular part 61 and the second annular part 62, one end of the first annular part 61 facing the annular groove 64 is provided with a plurality of convex parts 65 distributed at intervals, and the convex part 65 extends towards the second annular part 62. It can be understood that the first annular part 61, second annular part 62 and connection part 63 are integrally molded.

The sealing ring 6 is installed on the barrel lid 3 through the first annular part 61. It can be understood that the first annular part 61 can be fixed on the barrel lid 3 by gluing, clamping and screwing, and the opening of the annular groove 64 faces away from the storage space 41.

When the barrel lid 3 covers the barrel body 4, one end of the second annular part 62 abuts against an opening edge of the barrel lid 3, and another end of the second annular part 62 abuts against the convex part 65.

In this embodiment, when the barrel lid 3 covers the barrel body 4, the opening edge of the barrel body 4 will press the second annular part 62 in the direction of the first annular part 61. The second annular part 62 is in contact with the first annular part 61, thus ensuring the sealing performance of the barrel lid 3 covering the barrel body 4. In addition, the arrangement of the convex part 65 makes the first annular part 61 easily separate from the second annular part 62 when the barrel lid 3 is lifted from the barrel body 4, thus prolonging the service life of the sealing ring 6.

In an embodiment, as shown in FIG. 2, the vacuum food storage barrel further includes a storage box 7 detachably installed on the barrel lid 3 or the barrel body 4 and positioned in the storage space 41. Understandably, the storage box 7 can be detachably installed on the barrel lid 3 or the barrel body 4 through a clamping structure, a locking structure and the like. In this embodiment, different foods can be stored in the storage box 7 and the barrel body 4, which improves the applicability and universality of the vacuum food storage barrel.

In an embodiment, the barrel lid 3 is further provided with a desiccant (not shown in the figures) detachably installed on the barrel lid 3, and the desiccant is used for drying the storage space 41. Further, the barrel lid 3 is provided with a storing space communicating with the storage space 41, and the desiccant is detachably installed in the storage space 41. In this embodiment, the desiccant can ensure the dryness of the storage space 41.

The above are merely the preferred embodiments of the vacuum food storage barrel of the present application, and are not intended to limit the application. Any modification, equivalent substitution and improvement made within the spirit and principle of this application shall be included in the protection scope of this application.

What is claimed is:

1. A vacuum food storage barrel, comprising a vacuum pump assembly, an induction assembly, a barrel lid, and a barrel body provided with a storage space; wherein
the barrel lid is rotatably installed on the barrel body and used for covering the storage space;
the vacuum pump assembly and the introduction assembly are both installed on the barrel lid, and the vacuum pump assembly and the introduction assembly are electrically connected; and
the induction assembly is used for pumping the storage space into a vacuum state through the vacuum pump assembly when the barrel lid is lifted on the barrel body.

2. The vacuum food storage barrel of claim 1, wherein the vacuum food storage barrel further comprises a pressure relief assembly and a lock hook rotatably installed on the barrel lid, a clamping part is arranged on an outer wall of the barrel body; the barrel lid covers the barrel body through the lock hook clamped on the clamping part; the lock hook is used for releasing the pressure of the storage space through the pressure relief assembly when the lock hook is disengaged from the clamping part.

3. The vacuum food storage barrel of claim 2, wherein the barrel lid is provided with a pressure relief hole, and the pressure relief assembly comprises a first elastic member and a pushing piece slidably installed on the barrel lid; two opposite sides of the pushing piece are respectively provided with a sealing part and a guide rod; the first elastic member is sleeved on the guide rod and abutted with the barrel lid;
the pushing piece is also provided with a pushing part abutting against the lock hook;
when the lock hook abuts against the clamping part, a rebound force of the first elastic member drives the sealing part to seal the pressure relief hole; and
when the lock hook is disengaged from the clamping part, the lock hook drives the pushing piece to move by the pushing part, so that the sealing part unblocks the pressure relief hole.

4. The vacuum food storage barrel of claim 1, wherein the barrel body is further provided with a trigger part; the induction assembly comprises a trigger lever, a second elastic member and a trigger switch electrically connected with the vacuum pump assembly; one end of the trigger lever is abutted with the trigger switch and used for triggering the trigger switch, and another end of the trigger lever is abutted with or detached from the trigger part; the second elastic member is sleeved on the trigger lever and abutted with the barrel lid; and
when the barrel lid covers the barrel body, the trigger part drives the trigger lever to move to trigger the trigger switch, and the vacuum pump assembly pumps the storage space into a vacuum state.

5. The vacuum food storage barrel of claim 1, wherein the barrel lid is provided with a mounting groove, and an inner wall of the mounting groove is provided with an air suction hole communicating with the storage space; the vacuum food storage barrel further comprises a check valve installed in the air suction hole;
the vacuum pump assembly comprises an accommodation shell provided with an accommodation space, and a vacuum pump and a control panel both installed in the accommodation space; the control panel is electrically connected with both the vacuum pump and the induction assembly;
the accommodation shell is provided with an insertion part, and the insertion part is provided with a through hole communicated with the accommodation space, and the air suction hole of the vacuum pump is communicated with the through hole; and
when the accommodation shell is installed in the mounting groove, the check valve is inserted into the through hole, and the through hole communicates with the storage space through the check valve.

6. The vacuum food storage barrel of claim 5, wherein the accommodation shell is provided with a first electrical contact electrically connected with the control panel, and the mounting groove is provided with a second electrical contact electrically connected with the induction assembly; and
when the accommodation shell is installed in the mounting groove, the first electrical contact is electrically connected with the second electrical contact.

7. The vacuum food storage barrel of claim 5, wherein the vacuum pump assembly further comprises a vacuum sensor installed in the accommodation space and electrically connected with the control panel, and the vacuum sensor is communicated with the through hole and used for detecting a vacuum degree of the storage space.

8. The vacuum food storage barrel of claim 1, wherein the barrel lid comprises an upper lid and a lower lid installed on the upper lid, and an internal space is arranged between the upper lid and the lower lid; the vacuum pump assembly is detachably installed on the upper lid, and the induction assembly is installed in the internal space.

9. The vacuum food storage barrel of claim 1, wherein the vacuum food storage barrel further comprises a sealing ring, the sealing ring comprises a first annular part, a second annular part and a connection part connected between the first annular part and the second annular part; an annular groove is arranged between the first annular part and the second annular part, one end of the first annular part facing the annular groove is provided with a plurality of convex parts distributed at intervals, and the convex part extends towards the second annular part;
the sealing ring is installed on the barrel lid through the first annular part; and
when the barrel lid covers the barrel body, one end of the second annular part abuts against an opening edge of the barrel lid, and another end of the second annular part abuts against the convex part.

10. The vacuum food storage barrel of claim 1, wherein the vacuum food storage barrel further comprises a storage box detachably installed on the barrel lid or the barrel body and positioned in the storage space; and/or
the barrel lid is also provided with a desiccant detachably installed on the barrel lid, and the desiccant is used for drying the storage space.
